(19) United States
(12) Patent Application Publication
(10) Pub. No.: US 2021/0166306 A1
(43) Pub. Date: Jun. 3, 2021

(54) ELECTRONIC DEVICE AND PAYMENT INFORMATION OUTPUT METHOD THEREOF

(71) Applicant: Samsung Electronics Co., Ltd., Gyeonggi-do (KR)

(72) Inventors: Yoonho LEE, Gyeonggi-do (KR); Hanna KIM, Gyeonggi-do (KR); Byungin YU, Gyeonggi-do (KR); Sungju PARK, Gyeonggi-do (KR)

(21) Appl. No.: 17/251,907

(22) PCT Filed: Jun. 4, 2019
(86) PCT No.: PCT/KR2019/006731

§ 371 Date: Dec. 14, 2020

(30) Foreign Application Priority Data
Jun. 19, 2018 (KR) 10-2018-0070126

(51) Int. Cl. G06Q 40/02; G06Q 20/10; G06Q 20/32; G06F 16/587

(52) U.S. Cl. CPC G06Q 40/02; G06F 16/587; G06Q 20/3221; G06Q 20/108

(57) ABSTRACT

An electronic device is disclosed. The electronic device may comprise: a display; a memory; and a processor functionally connected to the display and the memory, and when at least one photograph datum is generated, storing the at least one photograph datum in association with capturing time information and capturing place information. The electronic device may identify payment place information and payment time information associated with at least one piece of payment information, and may display, on the display, the identified payment place information and payment time information together with payment information associated with photograph data extracted on the basis of the capturing time information, the capturing place information, the payment place information, and the payment time information. In addition, various embodiments recognized through the specification are possible.

### TECHNICAL FIELD

Embodiments disclosed in this specification relate to an electronic payment technology.

### BACKGROUND ART

In addition to voice communication and data communication, portable electronic devices may support various functions such as taking pictures, tracking locations, and the like.

For example, the portable electronic devices may provide an electronic payment function by embedding an electronic payment function to communicate with an external electronic device (a payment terminal). The portable electronic devices may provide the electronic payment function not only in online stores but also in offline stores.

The portable electronic devices may output the provided payment information, at a point in time when the payment information is generated or after a predetermined period (e.g., a week). The payment information may include payment time information, payment amount information, information about a payment place and payment name, and the like.

### DISCLOSURE

### Technical Problem

The conventional portable electronic devices may output payment information including a simple text. In this case, after a user's memory has been vague, the simple text was not helpful for the user to remember the statement of a payment.

Various embodiments disclosed in this specification provide an electronic device capable of providing a clue for remembering user environment information (or a situation at the time of expenditure) at the time of making the output payment, and a method of outputting payment information.

### Technical Solution

According to an embodiment disclosed in this specification, an electronic device may include a display, a memory, and a processor operatively connected to the display and the memory, and for storing at least one piece of photo data in association with capturing time information and capturing place information when the at least one piece of photo data is generated. The memory may store instructions that, when executed, cause the processor to identify payment place information and payment time information that are associated with at least one piece of payment information, to extract photo data, in which a capturing place is within a specified distance from a payment place of the payment information and in which a capturing time is within a specified time period from a payment time of the payment information, among the at least one piece of photo data based on the capturing time information, the capturing place information, the payment place information, and the payment time information, to determine whether category information of an object included in the extracted photo data corresponds to business type information of the payment information, and to output the extracted photo data on the display together with the at least one piece of payment information when the category information corresponds to the business type information.

According to an embodiment disclosed in this specification, the method may include identifying payment place information associated with at least one piece of payment information, and payment time information included in the at least one piece of payment information, extracting photo data, in which a capturing place is within a specified distance from a payment place of the payment information and in which a capturing time is within a specified time period from a payment time of the payment information, among at least one piece of photo data based on the capturing time information and the capturing place information of the at least one piece of photo data, the payment place information, and the payment time information, determining whether category information of an object included in the extracted photo data corresponds to business type information of the payment information, and when the category information corresponds to the business type information, outputting the extracted photo data on a display together with the at least one piece of payment information.

### Advantageous Effects

According to the embodiments disclosed in this specification, it is possible to provide a clue for easily remembering user environment information at the time of payment. Besides, a variety of effects directly or indirectly understood through the specification may be provided.

### DESCRIPTION OF DRAWINGS

FIG. 1 illustrates an example of a UI screen outputting photo data and schedule information, which are associated with payment information, according to an embodiment.

FIG. 2 illustrates a block diagram of an electronic device outputting photo data associated with payment information according to an embodiment.

FIG. 3 is a flowchart illustrating a payment information outputting method of an electronic device according to an embodiment.

FIG. 4 is a diagram for describing a photo data outputting method associated with payment information by a plurality of apps, according to an embodiment.

FIG. 5A is a UI screen for displaying schedule information associated with payment information according to an embodiment.

FIG. 5B is another example of a UI screen for displaying photo data associated with payment information according to an embodiment.

FIG. 6 illustrates a method of grouping payment information and outputting photos for each group according to an embodiment.

FIG. 7A is an example of a UI screen for outputting payment information classified for each business type according to an embodiment.

FIG. 7B is an example of a UI screen for outputting payment information classified for each day of the week according to an embodiment.

FIG. 7C is an example of a UI screen for outputting payment information classified for each zone according to an embodiment.

FIG. 7D is another example of a UI screen for outputting payment information classified for each business type according to another embodiment.

FIG. 8A is an example of a UI screen for displaying payment information classified for each zone in map data according to an embodiment.

FIG. 8B is an example of a UI screen for displaying payment information classified for each business type in map data according to an embodiment.

FIG. 8C is an example of a UI screen for displaying payment information classified for each day of the week in map data according to an embodiment.

FIG. 9 is an example of a UI screen for sharing photo data associated with payment information according to an embodiment.

FIG. 10 illustrates a block diagram of an electronic device outputting payment information in a network environment according to various embodiments.

With regard to description of drawings, the same or similar components will be marked by the same or similar reference signs.

### MODE FOR INVENTION

Hereinafter, various embodiments of the disclosure will be described with reference to accompanying drawings. However, it should be understood that the disclosure is not intended to be limited to a specific embodiment, but intended to include various modifications, equivalents, and/or alternatives of the corresponding embodiment.

Various embodiments of the disclosure and terms used herein are not intended to limit the technical features described in the disclosure to specific embodiments, and it should be understood that the embodiments and the terms include modification, equivalent, or alternative on the corresponding embodiments described herein. With regard to description of drawings, similar or related components may be marked by similar reference marks/numerals. The singular form of the noun corresponding to an item may include one or more of items, unless interpreted otherwise in context. In the disclosure, the expressions “A or B”, “at least one of A and B”, “at least one of A or B”, “A, B, or C”, “at least one of A, B, and C”, and “at least one of A, B, or C” may include all combinations of the associated listed items. The terms, such as “first” or “second” may be used to simply distinguish the corresponding component from the other component, but do not limit the corresponding components in other aspects (e.g., importance or order). When a component (e.g., a first component) is referred to as being “coupled with/to” or “connected to” another component (e.g., a second component) with or without the term of “operatively” or “communicatively”, it may mean that a component is connectable to the other component, directly (e.g., by wire), wirelessly, or through the third component.

The electronic device according to various embodiments disclosed in the disclosure may be various types of devices. The electronic device may include, for example, a portable communication device (e.g., a smartphone), a computer device, a portable multimedia device, a mobile medical appliance, a camera, a wearable device, or a home appliance. The electronic device according to an embodiment of the disclosure should not be limited to the above-mentioned devices.

Hereinafter, according to various embodiments, electronic devices will be described with reference to the accompanying drawings. In this specification, the term “user” used herein may refer to a person who uses an electronic device or may refer to a device (e.g., an artificial intelligence electronic device) that uses an electronic device.

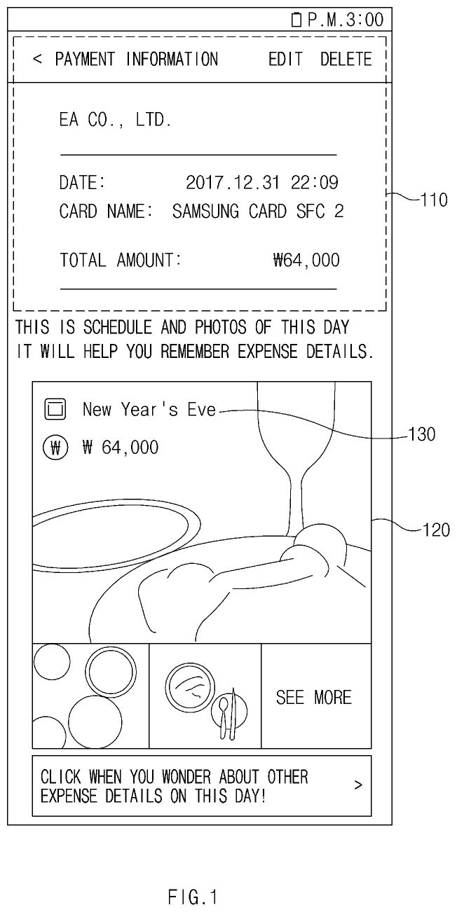

FIG. 1 illustrates an example of a UI screen outputting photo data and schedule information, which are associated with payment information, according to an embodiment.

Referring to FIG. 1, according to an embodiment, when outputting payment information 110, an electronic device may output photo data 120 associated with the payment information 110 on a display. For example, the electronic device may extract at least one piece of photo data 120, in which the capturing place is within a specified distance (e.g., 100 m) from a payment place, based on payment place information associated with the payment information 110 and capturing place information associated with the photo data 120 and then may output the extracted at least one piece of photo data 120. Additionally or alternatively, the electronic device may extract the photo data 120, in which the capturing time is within a specified time period from the payment time, based on payment time information included in the payment information and capturing time information of the photo data stored in a memory and then may output the extracted at least one piece of photo data 120. When the extracted photo data includes pieces of photo data, the processor 260 may display photo data, which is closest to a payment time in time domain, from among the extracted pieces of photo data in the first size, and may display the remaining pieces of photo data in the second size (less than the first size).

According to an embodiment, the electronic device 20 may output schedule information 130 corresponding to the payment information 110 together with the payment information 110 and the photo data 120 on the display. For example, the electronic device may extract schedule information associated with the payment time included in the payment information 110, and may output the extracted schedule information 130 by overlaying the extracted schedule information on the photo data 120 or display the extracted schedule information together with a photo in a separate area. For example, the found schedule information may include at least one of schedule information temporally overlapping with the payment time, or schedule information in which time information included in the schedule information is within a specified time period from the payment time. The temporally overlapping may mean that the payment time is included within the time range of the found schedule information. The fact of “within the specified time period from the payment time” may mean that the schedule information is included within the specified error time range before or after the payment time.

According to the above-described embodiment, the electronic device may output photo data and schedule information corresponding to the payment place or payment time together with the payment information, and thus may provide a clue that allows the user to easily remember user environment information at the time of a payment.

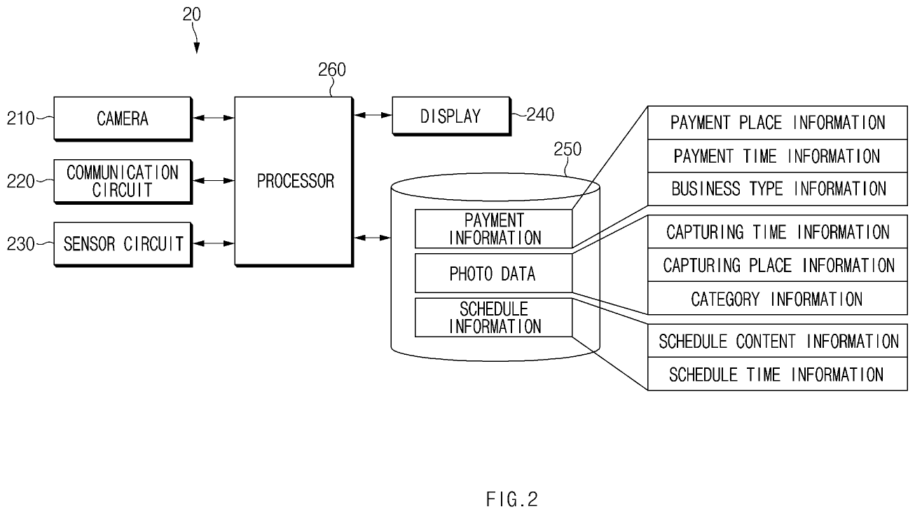

FIG. 2 illustrates a block diagram of an electronic device outputting photo data associated with payment information according to an embodiment.

Referring to FIG. 2, an electronic device 20 may include a camera 210, a communication circuit 220, a sensor circuit 230, a display 240, a memory 250, and a processor 260. In an embodiment, some components may be omitted or additional components may be further included. In an embodiment, some components may be combined to form one entity, which may identically perform functions of some components before the combination. In an embodiment, the electronic device 20 may be implemented with a plurality of hardware devices. For example, the electronic device 20 may be composed of a server device and a client device.

According to an embodiment, the camera 210 may capture still images and videos. The camera 210 may include at least one or more pieces of lens assembly, an image sensor, an image signal processor, or a lens driver. The lens assembly may be configured to have an angle of view and a focal length. The image sensor may obtain an image corresponding to an external object (e.g., a subject) by converting light delivered from the external object through the lens assembly into an electrical signal. The image obtained from the camera 210 may be an image that is in focus in a field of view (FOV) due to the attribute of the lens assembly. The image sensor may be implemented with a CCD sensor or a CMOS sensor. The lens driver may adjust the position of the lens assembly depending on the instruction of the image signal processor or the processor 260. At least part of pieces of photo data obtained through the camera 210 may be stored in association with capturing place information. At least part of the pieces of photo data may be stored in association with payment information.

According to an embodiment, the communication circuit 220 may form a communication channel capable of communicating with an external electronic device (e.g., the server of a credit card issuer). For example, the communication channel may include a mobile communication channel such as WiFi, 3rd generation (3G), 4th generation (4G), or the like. The communication circuit 220 may further establish a communication channel capable of receiving current time information from another external electronic device (e.g., a base station).

According to an embodiment, the sensor circuit 230 may calculate the location information of the electronic device 20. For example, the sensor circuit may include a global positioning system (GPS) receiver.

According to an embodiment, the display 240 may output at least one of photo data or schedule information together with the payment information. The display 240, for example, the electronic device 20 may display various contents (e.g., texts, images, videos, icons, and/or symbols). The display 240 may include, for example, a liquid crystal display (LCD), a light-emitting diode (LED) display, an organic LED (OLED) display, or an electronic paper display.

According to an embodiment, the memory 250 may store at least one piece of payment information and at least one piece of photo data. The payment information may include payment time information, payment amount information, payment place name information (e.g., a workplace name, or the like), and the like. The respective payment information may be stored in association with at least one of the payment place information or business type information. The respective photo data may be stored in association with capturing time information and capturing place information. The memory 250 may further store at least one piece of schedule information. The schedule information may include schedule content information (e.g., a schedule title, or the like), schedule time information, and the like.

For example, the memory 250 may store commands or data associated with at least one other component(s) of the electronic device 20. The memory 250 may be a volatile memory (e.g., a random access memory (RAM) or the like), a nonvolatile memory (e.g., a read only memory (ROM), a flash memory, or the like), or a combination thereof.

The processor 260 may perform data processing or an operation associated with a control and/or a communication of at least one other component(s) of the electronic device 20 by using the instructions stored in the memory 250. For example, the processor 260 may include at least one a central processing unit (CPU), a graphic processing unit (GPU), a microprocessor, an application processor (AP), and an application specific integrated circuit (ASIC), a field programmable gate arrays (FPGA) and may have a plurality of cores.

According to an embodiment, when capturing a photo using the camera 210, the processor 260 may obtain time information (hereinafter referred to as “capturing time information”) at the time of capturing photo data. In this regard, the electronic device 20 may generate the current time or may receive the current time from the outside. When capturing photo data, the processor 260 may further obtain location information (hereinafter referred to as “capturing place information”) of the electronic device 20, using the sensor circuit 230. The processor 260 may store the captured photo data in the memory 250 in association with at least one of capturing time information and capturing place information. Alternatively, the processor 260 may include at least one of capturing time information and capturing place information, as tag information of photo data.

According to an embodiment, when obtaining payment information from an external electronic device through the communication circuit 220, the processor 260 may identify the location information (hereinafter referred to as “payment place information”) of the electronic device 20 upon obtaining payment information using the sensor circuit 230, and may store the obtained payment information in the memory 250 in association with payment place information.

According to an embodiment, when outputting payment information (e.g., an electronic receipt) on the display 240, the processor 260 may output at least one of photo data associated with the payment information or schedule information associated with the payment information. For example, the time of outputting payment information may include at least one of the time of generating payment information or the time when the output of payment information is requested by a user. For example, the processor 260 may extract photo data, in which the capturing place is within a specified distance from the payment place of the payment information to be output (or output) and in which the capturing time is within a specified time period from the payment time of the payment information to be output (or output), from among at least a piece of photo data stored in the memory 250 based on capturing time information, capturing place information, payment place information, and payment time information.

According to an embodiment, when extracting the photo data, the processor 260 may extract at least one object included in the extracted photo data (photo image), and may classify, generate, and identify category information corresponding to the type of the extracted object. The processor 260 may extract features of the extracted object, and may classify and generate the category of the extracted object, depending on identifying the categories of features matched with the extracted features among features of a plurality of categories previously stored in the memory 250. According to various embodiments, the processor 260 may generate category information corresponding to the type of the object included in the photo data at a point in time when the photo data is generated, and may store the generated category information in association with the photo data. Afterward, when extracting photo data associated with payment information, the processor 260 may identify category information associated with the extracted photo data. For example, the category information may be the type information of the at least one object. For example, the category information may include beverages (e.g., coffee, or the like), food, clothing, cosmetics, furniture, flowers, groceries, or the like.

According to an embodiment, the processor 260 may determine whether the category information of the object included in the extracted photo data corresponds to the business type information of the payment information. For example, the business type information may include a cafe, eating out (e.g., restaurants), shopping (e.g., clothing stores, cosmetic stores, furniture stores, or flower stores), marts, or the like. The business type information may be stored by being matched with the category information of an object capable of being captured at a payment place. For example, when the business type information of payment information is matched with the category information of the object included in the extracted photo data, the processor 260 may identify that the business type information of payment information corresponds to the category information of the extracted photo data. In an embodiment, the processor 260 may communicate with an external electronic device through the communication circuit 220 to obtain business type information corresponding to payment place name information of payment information from the external electronic device. The processor 260 may obtain business type information in at least one of a point in time when payment information is generated or a point in when payment information is output.

According to an embodiment, when the category information corresponds to the business type information, the processor 260 may output the extracted photo data to the display 240 together with the payment information. For example, the processor 260 may output the extracted photo data at the lower end of an area in which the payment information is output. When there are the extracted pieces of photo data, the processor 260 may output the pieces of photo data to the display 250 together with the payment information.

According to an embodiment, the processor 260 may extract schedule information corresponding to the payment time from the memory 250 and may output the extracted schedule information together with the payment information. For example, the processor 260 may extract schedule information, in which a schedule time is temporally overlapped with the capturing time of the extracted photo data and in which the schedule time is within the specified time period from the capturing time of the extracted photo data, among at least a piece of schedule information stored in the memory 250, and may output the extracted schedule information together with payment information. At this time, the processor 260 may output the content (text) of the extracted schedule information at a lower end of an area in which payment information is output. For example, the processor 260 may overlap the content of schedule information with the extracted photo data to display the overlapped result.

According to an embodiment, the processor 260 may classify pieces of payment information into a plurality of groups depending on a specified criterion, and may extract photo data associated with the payment information belonging to each group among at least a piece of photo data. For example, the pieces of payment information may include pieces of payment information included in a specified time period having the different payment time. The processor 260 may output information about each group and photo data associated with payment information belonging to each group, on the display 240. The each group information may include the total payment amount for each group determined based on the name of each group and payment amount information included in the pieces of payment information.

In an embodiment, the specified criterion may be associated with at least one of zone information, day-of-the-week information, or business type information. According to an embodiment, the processor 260 may identify information (e.g., “dong” information to which each payment place belongs) about at least one zone where a plurality of payment places (which are respectively associated with pieces of payment information) belong, and may classify the pieces of payment information into a plurality of groups based on the identified at least a piece of zone information. For example, the processor 260 may classify the pieces of payment information into a plurality of groups depending on grouping pieces of payment information belonging to a zone, where payment places are the same as each other, into a single group. According to an embodiment, the processor 260 may identify the day-of-the-week information to which the payment time of respective payment information belongs, based on pieces of payment time information respectively included in the pieces of payment information, and may classify the pieces of payment information into a plurality of groups based on the identified day-of-the-week information. For example, as grouping pieces of payment information having the same day of the week, to which payment time points belong, into a single group, the processor 260 may classify the pieces of payment information into a plurality of groups. According to an embodiment, the processor 260 may obtain business type information corresponding to pieces of payment information, and may classify the pieces of payment information into a plurality of groups based on the obtained business type information. For example, as grouping pieces of payment information having the same business type into a single group, the processor 260 may classify the pieces of payment information into a plurality of groups. According to the above-described embodiment, the processor 260 may provide a clue (photo data) capable of remembering user environment information at the time of payment belonging to each group, as well as information (group total payment amount) from classifying pieces of payment information depending on various criteria, thereby supporting users to easily remember their payment details.

In an embodiment, when extracting photo data associated with payment information belonging to each group from at least a piece of photo data, the processor 260 may extract photo data associated with payment information having the highest payment amount among pieces of photo data associated with payment information belonging to each group. Additionally or alternatively, the processor 260 may extract photo data associated with payment information closest to a payment time from pieces of photo data associated with payment information belonging to each group.

In an embodiment, the processor 260 may output the extracted photo data associated with payment information belonging to each group as it is, or may process and output the corresponding photo data. For example, the processor 260 may crop photo data associated with payment information belonging to each group in a specified shape (e.g., circle), and may output the cropped area. For another example, the processor 260 may convert the size of photo data associated with payment information of each group depending on the total payment amount for each group (e.g., to be proportional to the amount), and may output the size-converted photo data to the display 240 in association with the total payment amount for each group.

In an embodiment, the processor 260 may output other photo data associated with business type information of payment information at the lower end of an area in which payment information and photo data associated with the payment information are output (or to be output). For example, the processor 260 may output the group total payment amount of payment information belonging to a group according to business type information of payment information and photo data (e.g., representative photo data) associated with the corresponding group, among pieces of payment information at the lower end of an area where payment information and photo data associated with the payment information are output (or to be output).

In an embodiment, when there is no photo data associated with payment information, the processor 260 may extract other photo data captured in the payment place of the payment information at a time (e.g., other dates) outside the specified range from the payment time from the memory 250. The processor 260 may output other photo data extracted instead of photo data associated with payment information. The processor 260 may output other payment information (e.g., payment amount information or payment time information) associated with the other photo data together with the other photo data.

According to an embodiment, the processor 260 may obtain map data from the memory 250 and may display pieces of payment information on the obtained map data. In this case, the processor 260 may display pieces of payment information so as to distinguish a group to which pieces of payment information belong. For example, when pieces of payment information are classified into a plurality of groups depending on zone information, the processor 260 may display the total payment amount for each group in a location corresponding to the zone information of each group in the map data. For another example, when classifying pieces of payment information according to a payment place and day of the week according to payment time, the processor 260 may display payment moving path information for each day of the week by connecting locations respectively corresponding to payment places of pieces of payment information in the map data in order of payment time for each day of the week. For still another example, when sorting pieces of payment information depending on a payment place and business type, the processor 260 may display the payment amount and business type information of respective payment information at a location corresponding to the payment places of pieces of payment information in the map data. According to the above-described embodiment, upon displaying pieces of payment information using map data, the processor 260 may support a user to easily grasp a payment pattern.

According to an embodiment, the processor 260 may output shared photo data captured at a payment place of payment information. For example, while displaying the payment information list during another specified time period (e.g., monthly), the processor 260 may identify a user input to select a piece of payment information from the payment information list. When identifying the user input, the processor 260 may obtain the shared photo data associated with payment place information (e.g., a store name) of the selected payment information from an external electronic device, and may display the obtained shared photo data. The shared photo data may include photo data that is captured by at least one electronic device including the electronic device 20 at a payment place of payment information and transmitted to the external electronic device in association with the payment place information. To this end, the processor 260 may share (e.g., transmit) payment information, payment place information, and photo data associated with the payment information to an external electronic device in association with one another. According to the above-described embodiment, the processor 260 may output photo data captured by another user at a payment place, thereby supporting a user to easily memorize user environment information at the time of making a payment.

According to an embodiment, an electronic device (e.g., the electronic device 200 of FIG. 2) may include a display (e.g., the display 240 of FIG. 2), a memory (e.g., the memory 250 of FIG. 2), and a processor (e.g., the processor 260 of FIG. 2) operatively connected to the display and the memory, and for storing at least one piece of photo data in association with capturing time information and capturing place information when the at least one piece of photo data is generated. The memory may store instructions that, when executed, cause the processor to identify payment place information and payment time information that are associated with at least one piece of payment information, to extract photo data, in which a capturing place is within a specified distance from a payment place of the payment information and in which a capturing time is within a specified time period from a payment time of the payment information, among the at least one piece of photo data based on the capturing time information, the capturing place information, the payment place information, and the payment time information, to determine whether category information of an object included in the extracted photo data corresponds to business type information of the payment information, and to output the extracted photo data on the display together with the at least one piece of payment information when the category information corresponds to the business type information.

The instructions may, when executed, further cause the processor to identify at least one object included in the extracted photo data, and to generate category information to which the identified at least one object belongs.

The memory may further store at least one piece of schedule information. The instructions may, when executed, further cause the processor to extract schedule information corresponding to a payment time according to the payment time information among the at least one piece of schedule information and to output the extracted schedule information on the display.

The at least one piece of payment information may include pieces of payment information. The instructions may, when executed, further cause the processor to classify the pieces of payment information into a plurality of groups depending on a specified criterion, to identify a total payment amount for a respective group based on payment amount information of the pieces of payment information, to extract photo data associated with payment information, to which the respective group belongs, among the at least one piece of photo data, and to associate the photo data associated with the payment information belonging to the respective group with the total payment amount for the respective group to output the associated photo data on the display.

The instructions may, when executed, further cause the processor to identify at least one piece of zone information to which a plurality of payment places respectively associated with the pieces of payment information belong, and to classify the pieces of payment information into the plurality of groups based on the identified at least one piece of zone information.

The memory may further store map data. The instructions may, when executed, further cause the processor to display the total payment information for the respective group at a location corresponding to the zone information in the map data.

The instructions may, when executed, further cause the processor to identify day-of-the-week information corresponding to the pieces of payment information based on pieces of payment time information respectively associated with the pieces of payment information and to classify the pieces of payment information into the plurality of groups based on the identified day-of-the-week information.

The memory may further store map data. The instructions may, when executed, further cause the processor to output at least part of the respective pieces of payment information at a location corresponding to a payment place of the respective pieces of payment information in the map data, and to output a payment moving path that connects payment information for a respective group classified depending on the day-of-the-week information in a payment time order.

The instructions may, when executed, further cause the processor to obtain business type information corresponding to the pieces of payment information and to classify the pieces of payment information into the plurality of groups based on the obtained business type information.

The memory may further store map data. The instructions may, when executed, further cause the processor to output at least part of the respective payment information and the business type information, at a location corresponding to a payment place of the respective pieces of payment information in the map data.

The instructions may, when executed, further cause the processor to output photo data associated with payment information of the highest payment amount, among photo data associated with the payment information belonging to the respective group on the display in association with the total payment amount for the respective group.

The instructions may, when executed, further cause the processor to convert a size of photo data associated with payment information of the respective group depending on a total payment amount for the respective group and to output the converted photo data on the display in association with the respective group total payment amount.

The instructions may, when executed, further cause the processor to extract photo data in which the capturing place is within a specified distance from the payment place of the payment information, and to output the extracted photo data together with the payment information when photo data, in which the capturing place is within a specified distance from the payment place of the payment information and in which a capturing time is within a specified time period from the payment time of the payment information, among the at least one piece of photo data is present.

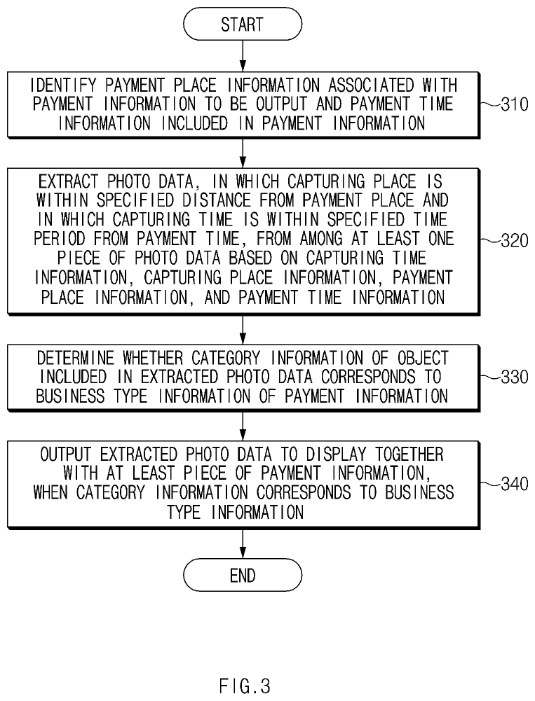

FIG. 3 is a flowchart illustrating a payment information outputting method of an electronic device according to an embodiment.

Referring to FIG. 3, in operation 310, the processor 260 may identify payment place information associated with payment information to be output and payment time information included in the payment information. For example, when a process of outputting the payment information is started, the processor 260 may identify payment place information and payment time information, which correspond to payment information to be output.

In operation 320, the processor 260 may extract photo data, in which the capturing place is within a specified distance from the payment place and in which the capturing time is within a specified time period from the payment time, from among at least a piece of photo data based on capturing time information, capturing place information, payment place information, and payment time information.

In operation 330, the processor 260 may determine whether the category information of an object included in the extracted photo data corresponds to the business type information of the payment information. For example, when the category information of an object included in the extracted photo data is matched with business type information, the processor 260 may determine that the category information corresponds to the business type information.

In operation 340, when the category information corresponds to the business type information, the processor 260 may output the extracted photo data to the display 240 together with the payment information. For example, the processor 260 may output the extracted photo data at the lower end of an area in which the payment information is displayed. According to various embodiments, the processor 260 may further extract schedule information corresponding to payment information from the memory 250, and may output the extracted schedule information such that the extracted schedule information overlaps with the extracted photo data.

According to the above-described embodiment, upon outputting at least one of photo data and schedule data associated with payment information when the processor 260 outputs the payment information, the processor 260 may support a user to easily memorize user environment information at the time of making a payment.

According to an embodiment, a payment information displaying method by an electronic device may include identifying payment place information associated with at least one piece of payment information, and payment time information included in the at least one piece of payment information, extracting photo data, in which a capturing place is within a specified distance from a payment place of the payment information and in which a capturing time is within a specified time period from a payment time of the payment information, among at least one piece of photo data based on the capturing time information and the capturing place information of the at least one piece of photo data, the payment place information, and the payment time information, determining whether category information of an object included in the extracted photo data corresponds to business type information of the payment information, and when the category information corresponds to the business type information, outputting the extracted photo data on a display together with the at least one piece of payment information.

The determining of whether the category information of the object included in the extracted photo data corresponds to the business type information of the payment information may include identifying at least one object included in the extracted photo data and generating category information to which the identified at least one object belongs.

According to an embodiment, the payment information displaying method may further include extracting schedule information corresponding to a payment time according to the payment time information among at least one piece of schedule information and outputting the extracted schedule information on the display.

The at least one piece of payment information may include pieces of payment information. The payment information displaying method may further include classifying the pieces of payment information into a plurality of groups depending on a specified criterion, identifying a total payment amount for a respective group based on payment amount information of the pieces of payment information, extracting photo data associated with payment information, to which the respective group belongs, among the at least one piece of photo data, and associating the photo data associated with the payment information belonging to the respective group with the total payment amount for the respective group to output the associated photo data on the display.

The classifying may include identifying at least one piece of zone information to which a plurality of payment places respectively associated with the pieces of payment information belong and classifying the pieces of payment information into the plurality of groups based on the identified at least one piece of zone information.

The classifying may include obtaining business type information corresponding to the pieces of payment information and classifying the pieces of payment information into the plurality of groups based on the obtained business type information.

The classifying may include identifying day-of-the-week information corresponding to the pieces of payment information based on pieces of payment time information respectively associated with the pieces of payment information, and classifying the pieces of payment information into the plurality of groups based on the identified day-of-the-week information.

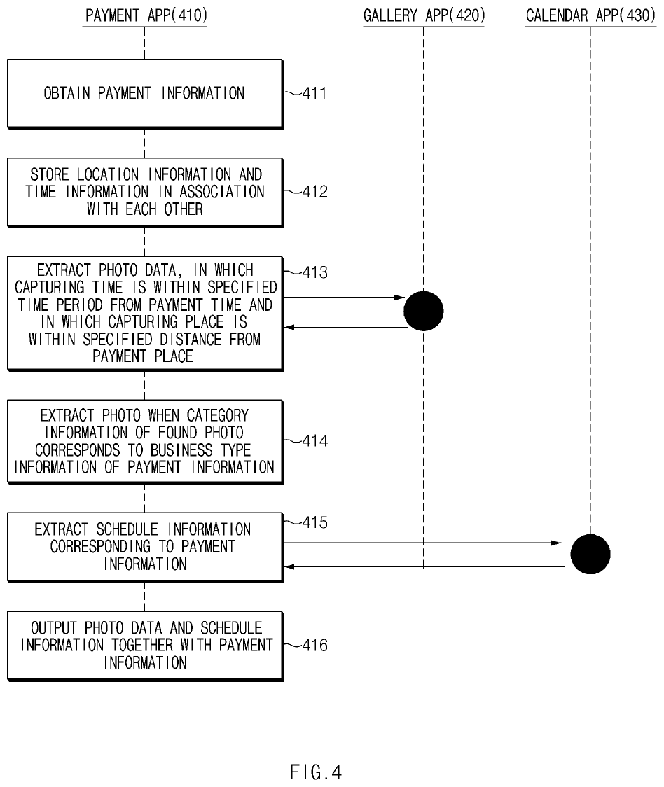

FIG. 4 is a diagram for describing a photo data outputting method associated with payment information by a plurality of apps, according to an embodiment.

Referring to FIG. 4, according to an embodiment, the processor 260 may include a payment app 410, a gallery app 420, and a calendar app 430. The payment app 410, the gallery app 420, and the calendar app 430 may be software modules implemented by the processor 260. For example, the function of each of the modules included in the processor 260 may be performed by the single processor 260 or may be performed by each separate processor.

In operation 411, the payment app 410 may obtain payment information from an external electronic device through the communication circuit 220 after an electronic payment is completely made.

In operation 412, when the payment app 410 obtains the payment information, the payment app 410 may identify payment place information that is the location information of the electronic device 20. The payment app 410 may identify payment time information, which is time information included in the payment information or time information at which the payment information is obtained. The payment app 410 may store the obtained payment information, payment time information, and payment place information in association with one another.

In operation 413, the payment app 410 may request the gallery app 420 to extract photo data associated with the payment information among at least a piece of photo data stored in the memory 250. For example, the payment app 410 may request photo data, in which the capturing place is within a specified distance from the payment place and in which the capturing time is within a specified time period from the payment time, from among at least a piece of photo data stored in the memory 250. The gallery app 420 may extract photo data, in which the capturing place is within a specified distance from the payment place and in which the capturing time is within a specified time period from the payment time, from among at least a piece of photo data at the request of the payment app 410, and may transmit the extracted photo data to the payment app 410.

In operation 414, when receiving the extracted photo data, the payment app 410 may determine whether category information of at least one object included in the corresponding photo data corresponds to business type information of the payment information.

In operation 415, the payment app 410 may request the calendar app 430 to extract schedule information corresponding to the payment information. For example, the payment app 410 may make a request for schedule information, which temporally overlaps with the payment time or which is within a specified time period from the payment time, from among at least a piece of schedule information stored in the memory 250 to the calendar app 430. The calendar app 430 may extract schedule information, which temporally overlaps with the payment time or which is within a specified time period from the payment time, from among the at least one piece of schedule information at the request of the payment app 410, and may transmit the extracted schedule information to the payment app 410. The payment app 410 may receive the extracted schedule information.

In operation 416, when category information of at least one object included in the extracted photo data corresponds to business type information of the payment information, the payment app 410 may output the extracted photo data together with the payment information. Additionally or alternatively, the payment app 410 may output the extracted schedule information together with the extracted photo data. For example, as described in FIG. 1, the payment app 410 may overlap the extracted schedule information (e.g., the schedule information 130 of FIG. 1) with the extracted photo data (the photo data 120 of FIG. 1), which is output at the lower end of an area where the payment information (e.g., the payment information 110 of FIG. 1) is displayed, and then may output the overlapped result.

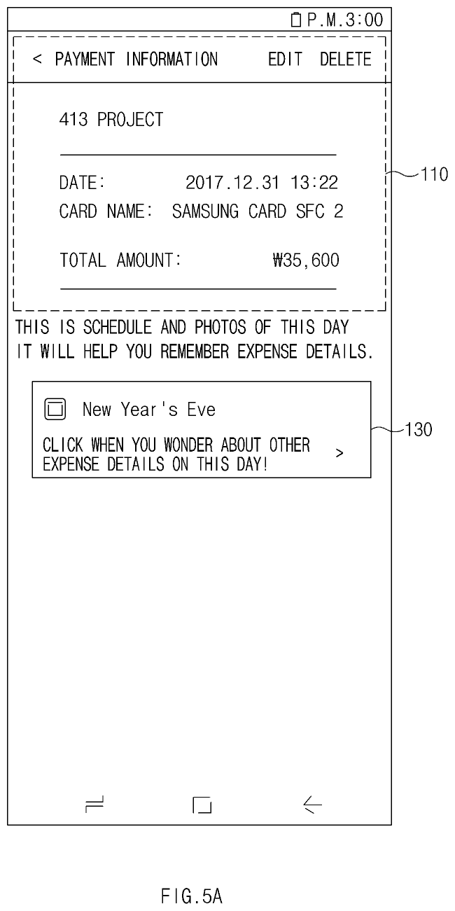

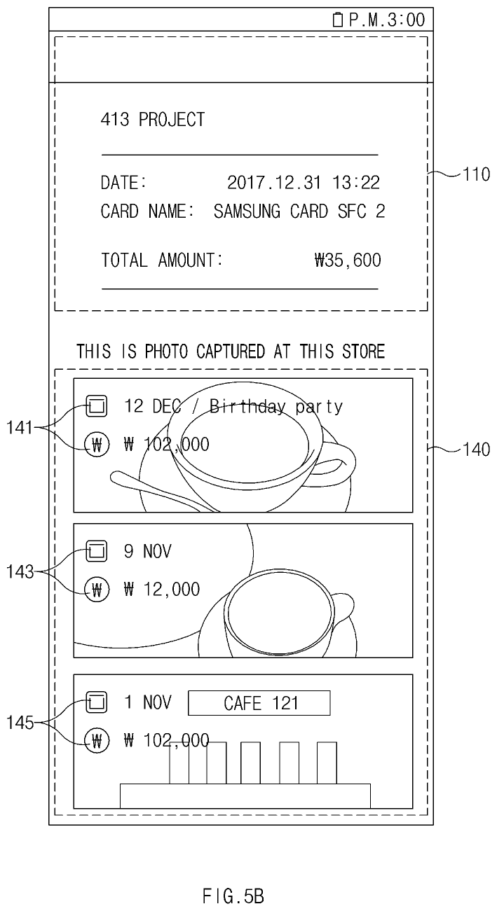

FIG. 5A is a UI screen for displaying schedule information associated with payment information according to an embodiment.

Referring to FIG. 5A, when photo data associated with the payment information 110 is not present and only the schedule information associated with the payment information 110 is present, the processor 260 may output only the schedule information 130 at the lower end of an area where the payment information 110 is displayed. For example, the processor 260 may output schedule information “New year's Eve” of the same date as the payment time of the payment information at the lower end of an area where the payment information (e.g., an electronic receipt) is displayed.

FIG. 5B is another example of a UI screen for displaying photo data associated with payment information according to an embodiment.

Referring to FIG. 5B, when there is no photo data associated with the payment information 110, the processor 260 may extract other photo data, which is captured at a time other than the specified time (e.g., another date) from the payment time (2017. 12. 31 13:22) of the payment information at the payment place of the payment information 110, from the memory 250 and may output the extracted other photo data. The processor 260 may output pieces of payment information 141, 143, and 145 (e.g., payment amount information and payment time information) associated with the other photo data together with the other photo data. For example, the processor 260 may extract the specified number (e.g., 3) of other pieces of photo data captured at a time other than the specified time from the payment time of the payment information, and may output the specified number of other photo data at the lower end of the area where the payment information is displayed, in order of recently capturing photos.

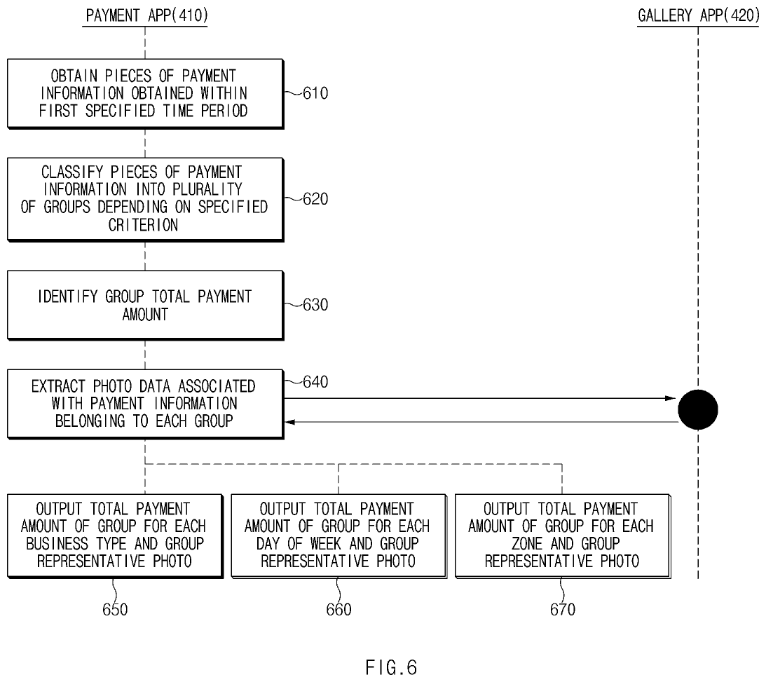

FIG. 6 illustrates a method of grouping payment information and outputting photos for each group according to an embodiment.

Referring to FIG. 6, in operation 610, the payment app 410 may obtain pieces of payment information obtained within a first specified time period from among pieces of payment information stored in the memory 250. For example, the first specified time period (e.g., 1 week) may be set by default or may be a time period set by a user. For example, the payment app 410 may obtain pieces of payment information obtained within the specified time period, in response to a user input to request to classify pieces of payment information.

In operation 620, the payment app 410 may classify the obtained pieces of payment information into a plurality of groups depending on a specified criterion. The specified criterion may be based on at least one of business type information of payment information (corresponding to the payment place name), day-of-the-week information to which the payment time belongs, or zone information of a payment place.

In operation 630, the payment app 410 may identify the total payment amount for each group based on the payment amount information of the pieces of payment information. For example, the payment app 410 may calculate and identify the total payment amount for each group by summing all payment amounts of payment information belonging to each group.

In operation 640, the payment app 410 may request the gallery app 420 to extract photo data (e.g., representative photo data of each group) associated with payment information belonging to each group. For example, the payment app 410 may extract photo data, in which the capturing time is within the second specified time period (e.g., 2 hours) from the payment time of the payment information belonging to each group and in which the capturing place is within a specified distance from the payment place of the payment information belonging to each group. For another example, the payment app 410 may determine whether there is photo data associated with the payment information belonging to each group in the order of the highest payment amount, and may extract representative photo data corresponding to the highest payment amount. For example, the photo data associated with the payment information may be photo data, in which the capturing time is within the second specified time period (e.g., 2 hours) from the payment time and in which the capturing place is within a specified distance from the payment place of the corresponding payment information. For another example, the payment app 410 may determine whether photo data associated with payment information is present in the order of the most recent payment information among payment information belonging to each group, and may extract representative photo data associated with the most recent payment information.

In at least one operation among operation 650 to operation 670, the payment app 410 may output representative photo data of each group together with the total payment amount for each group. For example, when the payment app 410 classifies pieces of payment information into groups for each business type, in operation 650, the payment app 410 may output the total payment amount of a group for each business type together with the representative photo data of the group for each business type. For another example, when the payment app 410 classifies pieces of payment information into groups for each day of the week, in operation 660, the payment app 410 may output the total payment amount of a group for each day of the week together with the representative photo data of the group for each day of the week. For example, when the payment app 410 classifies pieces of payment information into groups for each zone, in operation 670, the payment app 410 may output the total payment amount of a group for each zone together with the representative photo data of the group for each zone.

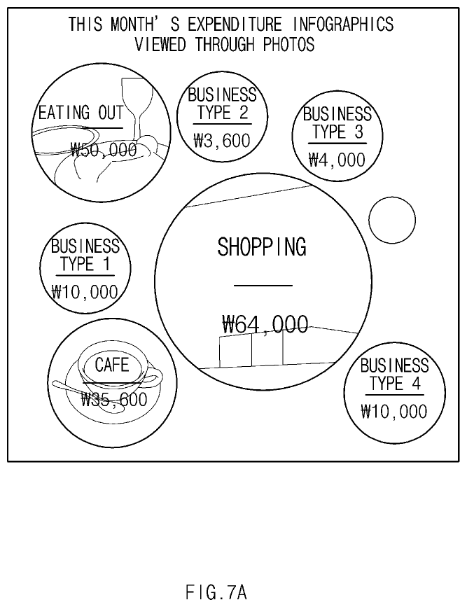

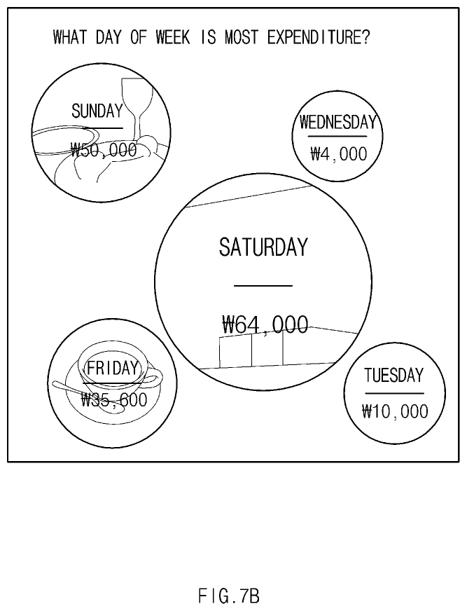

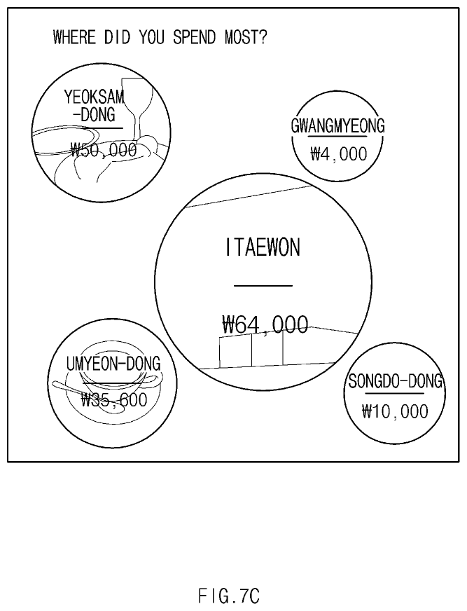

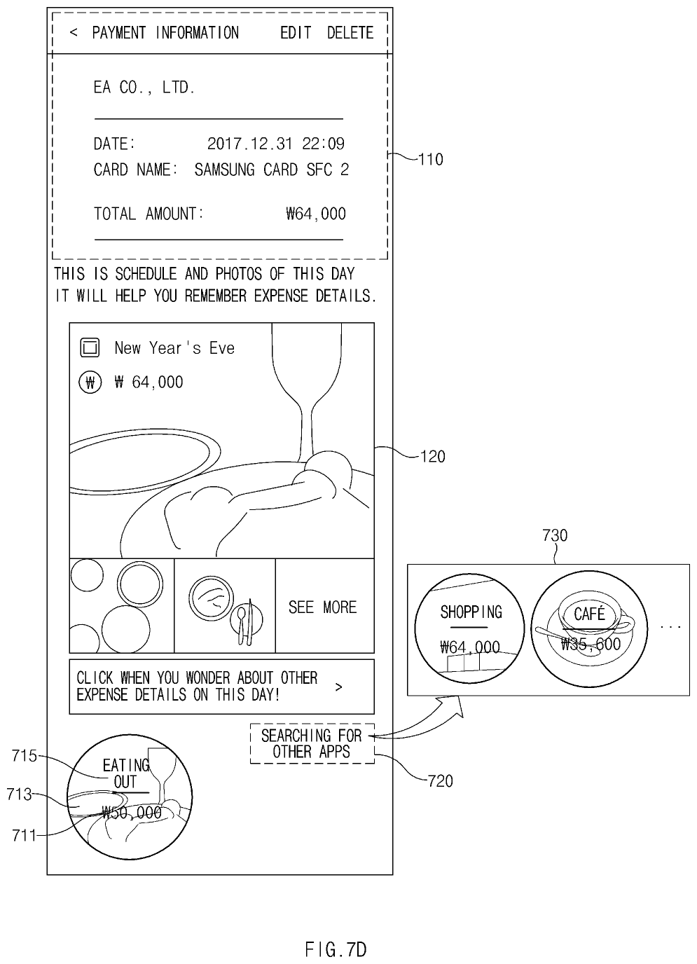

FIG. 7A is an example of a UI screen for outputting payment information classified for each business type according to an embodiment.

Referring to FIG. 7A, the processor 260 may classify pieces of payment information during the first specified time period (e.g., one month) into a plurality of groups based on business type information. For example, the business type information may be shopping, eating out, a cafe, a mart, and the like.

The processor 260 may extract photo data associated with payment information belonging to a group for each business type, may crop the extracted photo data in a circular shape, and may process (e.g., convert a size) the size of the cropped photo data to be proportional to the total payment amount for each group.

The processor 260 may output the processed photo data together with the group total payment amount and business type information (e.g., business type name). For example, among the extracted photo data, the processor 260 may display photo data associated with a shopping business type having the highest group total payment amount in the greatest circle, may display photo data associated with a catering business type having the second highest group total payment amount in the a second greatest circle, and may display photo data associated with a cafe business type having the third highest group total payment amount in the third greatest circle. The processor 260 may further output text information “This month's expenditure infographics viewed through photos” implying the criterion of group classification.

FIG. 7B is an example of a UI screen for outputting payment information classified for each day of the week according to an embodiment.

Referring to FIG. 7B, the processor 260 may classify pieces of payment information into a plurality of groups based on a day of the week according to payment time information. The days of the week may include Monday, Tuesday, Wednesday, Thursday, Friday, Saturday and Sunday.

The processor 260 may extract photo data associated with payment information belonging to a group for each day of the week and may process the extracted photo data. The processor 260 may output the processed photo data together with the group total payment amount and day-of-the-week information. The processor 260 may output text information “What day of the week is the most expenditure?” implying the criterion of group classification.

FIG. 7C is an example of a UI screen for outputting payment information classified for each zone according to an embodiment.

Referring to FIG. 7C, the processor 260 may classify pieces of payment information into a plurality of groups based on zone information to which payment place information belongs.

The processor 260 may extract photo data associated with payment information belonging to a group for each zone and may process the extracted photo data. The processor 260 may output the processed photo data together with the group total payment amount and zone information. The processor 260 may output text information “Where did you spend the most?” implying the criterion of group classification. The zone information may include zone names such as Yeoksam-dong, Itaewon, Umyeon-dong, Songdo-dong, Gwangmyeong, and the like.

FIG. 7D is another example of a UI screen for outputting payment information classified for each business type according to another embodiment.

Referring to FIG. 7D, the processor 260 may output other photo data 713 associated with business type information 715 of payment information 110 at the lower end of an area where the payment information 110 and photo data 120 associated with to the payment information 110 are displayed. For example, the processor 260 may classify pieces of payment information during the first specified time period into a plurality of groups depending on business type information, may determine the group total payment amount of the same business type group as the payment information 110 and photo data (e.g., representative photo data) associated with the corresponding group, and may output the determined group total payment amount and photo data associated with each group. For another example, the processor 260 may overlap the group total payment amount of “50,000” of payment information belonging to the business type group “eating out” of the payment information 110 with the representative photo data of group “eating out”, and then may output the overlapped result.

The processor 260 may further output a virtual button 720 for searching for a group according to other business type information other than a group according to business type information of the payment information 110. When the processor 260 identifies a user input to select the virtual button 720, the processor 260 may output a group total payment amount of at least another business type group and photo data 730 associated with the group.

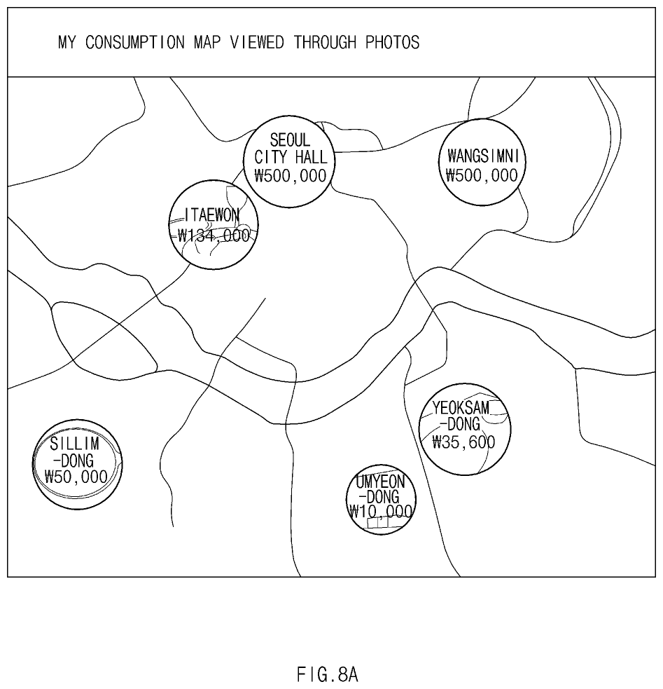

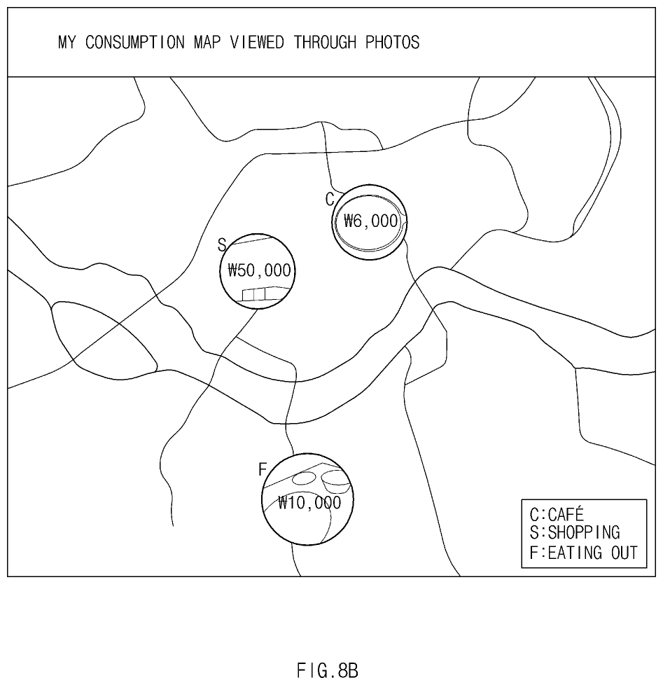

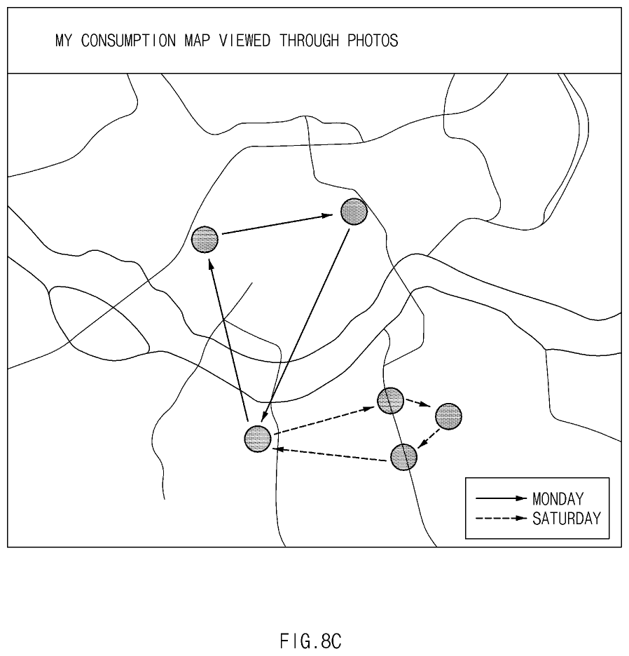

FIG. 8A is an example of a UI screen for displaying payment information classified for each zone in map data according to an embodiment.

Referring to FIG. 8A, when the processor 260 classifies pieces of payment information into a plurality of groups depending on a zone to which the payment place of respective payment information belongs, the processor 260 may display each group name (e.g., the name of “Dong”) and total payment amount information for each group at a location according to a zone group of map data. For example, when the zone to which the payment places of pieces of payment information belong is Itaewon, Seoul City Hall, Wangsimni, Yeoksam-dong, Umyeon-dong, or Sillim-dong, the processor 260 may display a circle corresponding to the amount size of the total payment amount information for each group at locations of Itaewon, Seoul City Hall, Wangsimni, Yeoksam-dong, Umyeon-dong, and Sillim-dong in the map data, and may display the total payment amount information for each group in each group circle. The processor 260 may output representative photo data associated with each zone group at a location according to the zone group of map data.

FIG. 8B is an example of a UI screen for displaying payment information classified for each business type in map data according to an embodiment.

Referring to FIG. 8B, when the processor 260 classifies pieces of payment information into a plurality of groups depending on the business type of payment information, the processor 260 may display payment amount information and each group symbol (e.g., S, C, or F) of respective payment information at a location corresponding to the payment place of respective payment information in the map data. The processor 260 may output photo data associated with respective payment information to a location corresponding to each payment place of map data. In this case, the size of a circle corresponding to respective payment information may be the same, or may correspond to (e.g., be proportional to) the payment amount of respective payment information.

FIG. 8C is an example of a UI screen for displaying payment information classified for each day of the week in map data according to an embodiment.

Referring to FIG. 8C, when the processor 260 classifies pieces of payment information into a plurality of groups depending on a day of the week to which the payment time of respective payment information belongs, the processor 260 may display a payment place at a location corresponding to a payment place of respective payment information in map data, and may display a payment moving path (a solid arrow and dotted arrow in FIG. 8C) for each day of the week that connects locations at the displayed payment place in the order of payment time for each day of the week. For example, when pieces of payment information of only Monday and Saturday are present, the processor 260 may display a payment place and payment moving path according to an order of payment time on Monday and a payment place and payment moving path according to an order of payment time on Saturday. The processor 260 may output representative photo data associated with respective payment information to a location corresponding to each payment place.

According to the above-described embodiment, upon displaying pieces of payment information in map data, the processor 260 may support a user to easily grasp a payment pattern.

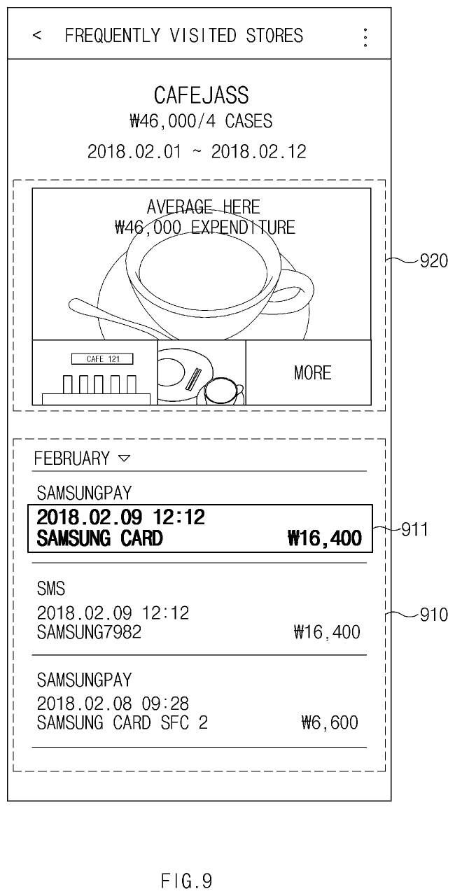

FIG. 9 is an example of a UI screen for sharing photo data associated with payment information according to an embodiment.

Referring to FIG. 9, the processor 260 may output shared photo data captured at a payment place of payment information. For example, while displaying a payment information list 910 for each month (e.g., February), the processor 260 may identify a user input to select a piece of payment information 911 from the payment information list 910. The processor 260 may obtain shared photo data 920 associated with payment place information (e.g., a store name) of the selected payment information 911 from an external electronic device in response to a user input, and may display the obtained shared photo data 920. The shared photo data 920 may include photo data that is captured by at least one electronic device including the electronic device 20 at a payment place of payment information and uploaded onto the external electronic device in association with the payment place information. According to the above-described embodiment, the processor 260 may output photo data captured by another user at a payment place, thereby supporting a user to easily memorize user environment information at the time of making a payment.

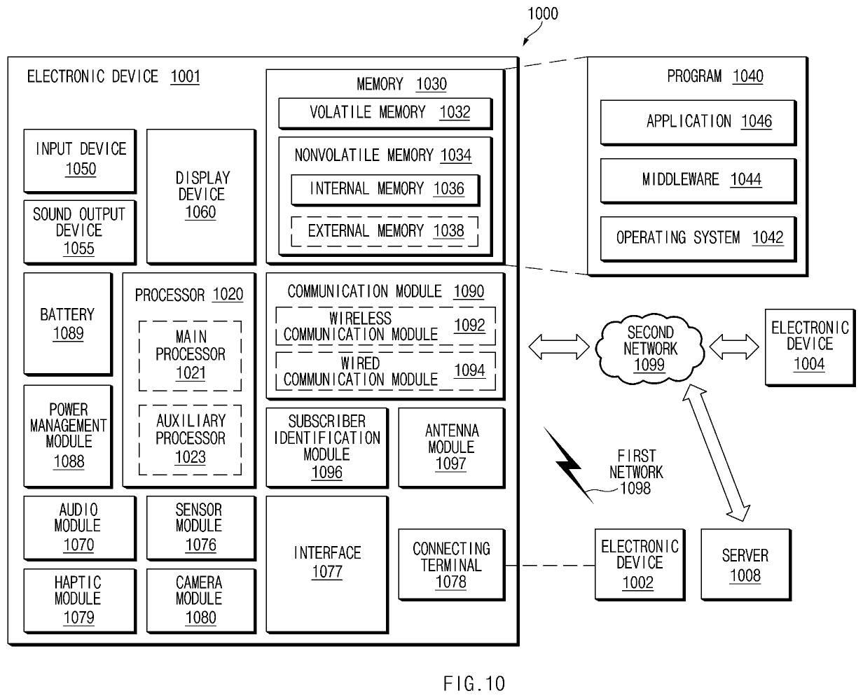

FIG. 10 is a block diagram illustrating an electronic device 1001 in a network environment 1000 according to various embodiments. Referring to FIG. 10, the electronic device 1001 in the network environment 1000 may communicate with an electronic device 1002 via a first network 1098 (e.g., a short-range wireless communication network), or an electronic device 1004 or a server 1008 via a second network 1099 (e.g., a long-range wireless communication network). According to an embodiment, the electronic device 1001 may communicate with the electronic device 1004 via the server 1008. According to an embodiment, the electronic device 1001 may include a processor 1020, memory 1030, an input device 1050, a sound output device 1055, a display device 1060, an audio module 1070, a sensor module 1076, an interface 1077, a haptic module 1079, a camera module 1080, a power management module 1088, a battery 1089, a communication module 1090, a subscriber identification module (SIM) 1096, or an antenna module 1097. In some embodiments, at least one (e.g., the display device 1060 or the camera module 1080) of the components may be omitted from the electronic device 1001, or one or more other components may be added in the electronic device 1001. In some embodiments, some of the components may be implemented as single integrated circuitry. For example, the sensor module 1076 (e.g., a fingerprint sensor, an iris sensor, or an illuminance sensor) may be implemented as embedded in the display device 1060 (e.g., a display).

The processor 1020 may execute, for example, software (e.g., a program 1040) to control at least one other component (e.g., a hardware or software component) of the electronic device 1001 coupled with the processor 1020, and may perform various data processing or computation. According to one embodiment, as at least part of the data processing or computation, the processor 1020 may load a command or data received from another component (e.g., the sensor module 1076 or the communication module 1090) in volatile memory 1032, process the command or the data stored in the volatile memory 1032, and store resulting data in non-volatile memory 1034. According to an embodiment, the processor 1020 may include a main processor 1021 (e.g., a central processing unit (CPU) or an application processor (AP)), and an auxiliary processor 1023 (e.g., a graphics processing unit (GPU), an image signal processor (ISP), a sensor hub processor, or a communication processor (CP)) that is operable independently from, or in conjunction with, the main processor 1021. Additionally or alternatively, the auxiliary processor 1023 may be adapted to consume less power than the main processor 1021, or to be specific to a specified function. The auxiliary processor 1023 may be implemented as separate from, or as part of the main processor 1021.

The auxiliary processor 1023 may control at least some of functions or states related to at least one component (e.g., the display device 1060, the sensor module 1076, or the communication module 1090) among the components of the electronic device 1001, instead of the main processor 1021 while the main processor 1021 is in an inactive (e.g., sleep) state, or together with the main processor 1021 while the main processor 1021 is in an active state (e.g., executing an application). According to an embodiment, the auxiliary processor 1023 (e.g., an image signal processor or a communication processor) may be implemented as part of another component (e.g., the camera module 1080 or the communication module 1090) functionally related to the auxiliary processor 1023.

The memory 1030 may store various data used by at least one component (e.g., the processor 1020 or the sensor module 1076) of the electronic device 1001. The various data may include, for example, software (e.g., the program 1040) and input data or output data for a command related thererto. The memory 1030 may include the volatile memory 1032 or the non-volatile memory 1034.

The program 1040 may be stored in the memory 1030 as software, and may include, for example, an operating system (OS) 1042, middleware 1044, or an application 1046.

The input device 1050 may receive a command or data to be used by other component (e.g., the processor 1020) of the electronic device 1001, from the outside (e.g., a user) of the electronic device 1001. The input device 1050 may include, for example, a microphone, a mouse, or a keyboard.

The sound output device 1055 may output sound signals to the outside of the electronic device 1001. The sound output device 1055 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 1060 may visually provide information to the outside (e.g., a user) of the electronic device 1001. The display device 1060 may include, for example, a display, a hologram device, or a projector and control circuitry to control a corresponding one of the display, hologram device, and projector. According to an embodiment, the display device 1060 may include touch circuitry adapted to detect a touch, or sensor circuitry (e.g., a pressure sensor) adapted to measure the intensity of force incurred by the touch.

The audio module 1070 may convert a sound into an electrical signal and vice versa. According to an embodiment, the audio module 1070 may obtain the sound via the input device 1050, or output the sound via the sound output device 1055 or a headphone of an external electronic device (e.g., an electronic device 1002) directly (e.g., wiredly) or wirelessly coupled with the electronic device 1001.

The sensor module 1076 may detect an operational state (e.g., power or temperature) of the electronic device 1001 or an environmental state (e.g., a state of a user) external to the electronic device 1001, and then generate an electrical signal or data value corresponding to the detected state. According to an embodiment, the sensor module 1076 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1077 may support one or more specified protocols to be used for the electronic device 1001 to be coupled with the external electronic device (e.g., the electronic device 1002) directly (e.g., wiredly) or wirelessly. According to an embodiment, the interface 1077 may include, for example, a high definition multimedia interface (HDMI), a universal serial bus (USB) interface, a secure digital (SD) card interface, or an audio interface.

A connecting terminal 1078 may include a connector via which the electronic device 1001 may be physically connected with the external electronic device (e.g., the electronic device 1002). According to an embodiment, the connecting terminal 1078 may include, for example, a HDMI connector, a USB connector, a SD card connector, or an audio connector (e.g., a headphone connector),

The haptic module 1079 may convert an electrical signal into a mechanical stimulus (e.g., a vibration or a movement) or electrical stimulus which may be recognized by a user via his tactile sensation or kinesthetic sensation. According to an embodiment, the haptic module 1079 may include, for example, a motor, a piezoelectric element, or an electric stimulator.

The camera module 1080 may capture a still image or moving images. According to an embodiment, the camera module 1080 may include one or more lenses, image sensors, image signal processors, or flashes.

The power management module 1088 may manage power supplied to the electronic device 1001. According to one embodiment, the power management module 1088 may be implemented as at least part of, for example, a power management integrated circuit (PMIC).

The battery 1089 may supply power to at least one component of the electronic device 1001. According to an embodiment, the battery 1089 may include, for example, a primary cell which is not rechargeable, a secondary cell which is rechargeable, or a fuel cell.

The communication module 1090 may support establishing a direct (e.g., wired) communication channel or a wireless communication channel between the electronic device 1001 and the external electronic device (e.g., the electronic device 1002, the electronic device 1004, or the server 1008) and performing communication via the established communication channel. The communication module 1090 may include one or more communication processors that are operable independently from the processor 1020 (e.g., the application processor (AP)) and supports a direct (e.g., wired) communication or a wireless communication. According to an embodiment, the communication module 1090 may include a wireless communication module 1092 (e.g., a cellular communication module, a short-range wireless communication module, or a global navigation satellite system (GNSS) communication module) or a wired communication module 1094 (e.g., a local area network (LAN) communication module or a power line communication (PLC) module). A corresponding one of these communication modules may communicate with the external electronic device via the first network 1098 (e.g., a short-range communication network, such as Bluetooth™, wireless-fidelity (Wi-Fi) direct, or infrared data association (IrDA)) or the second network 1099 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1092 may identify and authenticate the electronic device 1001 in a communication network, such as the first network 1098 or the second network 1099, using subscriber information (e.g., international mobile subscriber identity (IMSI)) stored in the subscriber identification module 1096.

The antenna module 1097 may transmit or receive a signal or power to or from the outside (e.g., the external electronic device) of the electronic device 1001. According to an embodiment, the antenna module 1097 may include one or more antennas, and, therefrom, at least one antenna appropriate for a communication scheme used in the communication network, such as the first network 1098 or the second network 1099, may be selected, for example, by the communication module 1090 (e.g., the wireless communication module 1092). The signal or the power may then be transmitted or received between the communication module 1090 and the external electronic device via the selected at least one antenna.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1001 and the external electronic device 1004 via the server 1008 coupled with the second network 1099. Each of the electronic devices 1002 and 1004 may be a device of a same type as, or a different type, from the electronic device 1001. According to an embodiment, all or some of operations to be executed at the electronic device 1001 may be executed at one or more of the external electronic devices 1002, 1004, or 1008. For example, if the electronic device 1001 should perform a function or a service automatically, or in response to a request from a user or another device, the electronic device 1001, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1001. The electronic device 1001 may provide the outcome, with or without further processing of the outcome, as at least part of a reply to the request. To that end, a cloud computing, distributed computing, or client-server computing technology may be used, for example.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1040) including one or more instructions that are stored in a storage medium (e.g., internal memory 1036 or external memory 1038) that is readable by a machine (e.g., the electronic device 1001). For example, a processor (e.g., the processor 1020) of the machine (e.g., the electronic device 1001) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

1. An electronic device comprising:
a display;
a memory; and
a processor operatively connected to the display and the memory,
wherein the memory stores instructions that, when executed by the processor, cause the processor to:
store at least one piece of photo data and capturing time information and capturing place information of the at least one piece of photo data in the memory in association with the at least one piece of photo data in response to generating the at least one piece of photo data;
identify payment place information and payment time information that are associated with at least one piece of payment information;
extract photo data, in which a capturing place is within a specified distance from a payment place of the payment information and in which a capturing time is within a specified time period from a payment time of the payment information, among the at least one piece of photo data based on the capturing time information, the capturing place information, the payment place information, and the payment time information;
determine whether category information of an object included in the extracted photo data corresponds to business type information of the payment information; and
when the category information corresponds to the business type information, output the extracted photo data on the display together with the at least one piece of payment information.

2. The electronic device of claim 1, wherein the instructions, when executed, cause the processor to:
identify at least one object included in the extracted photo data; and
generate category information to which the identified at least one object belongs.

3. The electronic device of claim 1, wherein the memory further stores:
at least one piece of schedule information, and
wherein the instructions, when executed, further cause the processor to:
extract schedule information corresponding to the payment time according to the payment time information among the at least one piece of schedule information; and
output the extracted schedule information on the display.

4. The electronic device of claim 1, wherein the at least one piece of payment information includes:
pieces of payment information, and
wherein the instructions, when executed, cause the processor to:
classify the pieces of payment information into a plurality of groups depending on a specified criterion;
identify a total payment amount for a respective group based on payment amount information of the pieces of payment information;
extract photo data associated with payment information, to which the respective group belongs, among the at least one piece of photo data; and
associate the photo data associated with the payment information belonging to the respective group with the total payment amount for the respective group to output the associated photo data on the display.

5. The electronic device of claim 4, wherein the instructions, when executed, cause the processor to:
identify at least one piece of zone information to which a plurality of payment places respectively associated with the pieces of payment information belong; and
classify the pieces of payment information into the plurality of groups based on the identified at least one piece of zone information.

6. The electronic device of claim 5, wherein the memory further stores map data, and
wherein the instructions, when executed, cause the processor to:
display the total payment information for the respective group at a location corresponding to the zone information in the map data.

7. The electronic device of claim 4, wherein the instructions, when executed, cause the processor to:
identify day-of-the-week information corresponding to the pieces of payment information based on pieces of payment time information respectively associated with the pieces of payment information; and
classify the pieces of payment information into the plurality of groups based on the identified day-of-the-week information.

8. The electronic device of claim 7, wherein the memory further stores map data, and
wherein the instructions, when executed, cause the processor to:
output at least part of the respective pieces of payment information at a location corresponding to a payment place of the respective pieces of payment information in the map data; and
output a payment moving path that connects payment information for a respective group classified depending on the day-of-the-week information in a payment time order.

9. The electronic device of claim 4, wherein the instructions, when executed, cause the processor to:
obtain business type information corresponding to the pieces of payment information; and
classify the pieces of payment information into the plurality of groups based on the obtained business type information.

10. The electronic device of claim 9, wherein the memory further stores map data, and
wherein the instructions, when executed, cause the processor to:
output at least part of the respective payment information and the business type information, at a location corresponding to a payment place of the respective pieces of payment information in the map data.

11. The electronic device of claim 4, wherein the instructions, when executed, cause the processor to:
output photo data associated with payment information of the highest payment amount, among photo data associated with the payment information belonging to the respective group on the display in association with the total payment amount for the respective group.

12. The electronic device of claim 4, wherein the instructions, when executed, cause the processor to:
convert a size of photo data associated with payment information of the respective group depending on a total payment amount for the respective group; and
output the converted photo data on the display in association with the respective group total payment amount.

13. The electronic device of claim 1, wherein the instructions, when executed, cause the processor to:
when the photo data, in which the capturing place is within the specified distance from the payment place of the payment information and in which the capturing time is within the specified time period from the payment time of the payment information, among the at least one piece of photo data is present,
extract photo data in which the capturing place is within the specified distance from the payment place of the payment information; and
output the extracted photo data together with the payment information.

14. A payment information displaying method by an electronic device, the method comprising:
identifying payment place information associated with at least one piece of payment information, and payment time information included in the at least one piece of payment information;
extracting photo data, in which a capturing place is within a specified distance from a payment place of the payment information and in which a capturing time is within a specified time period from a payment time of the payment information, among at least one piece of photo data based on the capturing time information and the capturing place information of the at least one piece of photo data, the payment place information, and the payment time information;
determining whether category information of an object included in the extracted photo data corresponds to business type information of the payment information; and
when the category information corresponds to the business type information, outputting the extracted photo data on a display together with the at least one piece of payment information.

15. The method of claim 14, wherein the determining of whether the category information of the object included in the extracted photo data corresponds to the business type information of the payment information includes:
identifying at least one object included in the extracted photo data; and
generating category information to which the identified at least one object belongs.
